(19) United States
(12) Patent Application Publication
(10) Pub. No.: US 2020/0234502 A1
(43) Pub. Date: Jul. 23, 2020

(54) Social Media Platform using Augmented Reality and Microlocation

(71) Applicant: Alexandre Van Anderlecht, Santa Monica, CA (US)

(72) Inventor: Alexandre Van Anderlecht, Santa Monica, CA (US)

(21) Appl. No.: 16/747,340

(22) Filed: Jan. 20, 2020

Related U.S. Application Data
(60) Provisional application No. 62/795,014, filed on Jan. 21, 2019.

(51) Int. Cl. G06T 19/00; H04L 12/58; H04N 21/431; H04W 4/029

(52) U.S. Cl. CPC G06T 19/006; H04L 51/32; G06T 2219/2004; H04W 4/029; H04N 21/4314

(57) ABSTRACT

A social media platform that enables augmented reality content that is positioned based on microlocation and allows the content to be generated by individuals who want to communicate virtually in real time with other nearby users. Through microlocation, the augmented reality content moves with the content generator.

### CROSS REFERENCE

This U.S. nonprovisional application claims the benefit of U.S. Patent Application Ser. No. 62/795,014, filed Jan. 21, 2019, which is hereby incorporated by reference in its entirety.

### FIELD

The invention relates to anchoring augmented reality content to users, locations or objects, including for social media, using microlocation technology.

### BACKGROUND

Social media platforms have evolved over the past few decades from being personal computer (PC) based to mobile platform-based applications. The changes have gone from MySpace to Facebook on PC to Facebook on mobile phones to the Tinder mobile app. The typical social media platform allows communication between two or more individuals by posting of content by an individual or organization for others to see and more recently to allow direct and immediate communication between two or more individuals or organizations. The more recent apps such as Tinder allow individuals or organizations to be geotagged by global positioning satellite (GPS) or locating technology; however, the technologies used have a location error of three meters or more. This means that in a crowded environment that the originator of the social media content could be one of many individuals or organizations.

Augmented reality is the overlaying of virtual items or content on an actual scene. A first major consumer use of augmented reality was the Pokémon Go app where virtual animated creatures were superimposed on the actual view through a mobile phone camera. Augmented reality is now being developed for numerous other uses.

### SUMMARY

A social media platform that places augmented reality content using microlocation technology and the system and method for anchoring the augmented reality content to a person, location or object are described herein.

In one aspect, a social media platform is provided. The platform comprises placing augmented reality content within one meter or less of the content generator, device, or a predetermined intended location, which may be a location defined relative to the content generator or device, with the augmented reality content and its location viewable by others located nearby using the social media platform. The placement of the augmented reality content is enabled by microlocation technology.

In another aspect, a system for a social media platform is provided. The system comprises of a device to view the augmented reality content in an actual setting and at least one of one or more signal receiving hardware, one or more signal transmitting hardware, one or more server and one or more device placing augmented reality content within one meter or less of the content generator, device, or a predetermined intended location, which may be a location defined relative to the content generator or device, with the augmented reality content and its location viewable by others located nearby using the social media platform.

In another aspect, a method for operating a social media platform is provided. The method comprises of wireless communication between a device to view the augmented reality content in an actual setting and at least one of one or more signal receiving hardware, one or more signal transmitting hardware, one or more server and one or more devices placing augmented reality content within one meter or less of the content generator, device, or a predetermined intended location, which may be a location defined relative to the content generator or device, with the augmented reality content and its location viewable by others located nearby using the social media platform.

Other aspects, features and embodiments are described further below.

The system for a social media platform wherein the system comprises at least one augmented reality content generator and at least one user with a device displaying the augmented reality content.

The system for a social media platform wherein the system comprises at least two users.

The system for a social media platform wherein the augmented reality content is placed within one meter of the desired location, wherein the desired location is a user, device or predetermined intended location.

The system for a social media platform wherein the augmented reality content is placed within 50 centimeters of the desired location, wherein the desired location is a user, device or predetermined intended location.

The system for a social media platform wherein the augmented reality content is placed within 5 centimeters of the desired location, wherein the desired location is a user, device or predetermined intended location.

The system for a social media platform wherein the user location is updated continuously.

The system for a social media platform wherein the user location is updated in discrete time intervals.

The system for a social media platform wherein the microlocation technology is by any radiofrequency technology.

The system for a social media platform wherein the radiofrequency technology is GPS or cellular mobile communication.

The system for a social media platform wherein the radiofrequency technology is a wireless personal area network technology or Near Field Communication (NFC).

The system for a social media platform wherein the radiofrequency technology is a wireless networking technology based on the IEEE 802.11 family of standards or Ultra Wideband (UWB).

The system for a social media platform wherein the content, placement or orientation of the augmented reality content is adjusted using the accelerometer, camera or compass of the user device.

The system for a social media platform wherein the augmented reality content is used for communicating between two or more users through their devices.

The system for a social media platform wherein the augmented reality content moves with the specific content generator.

The system for a social media platform wherein the augmented reality content is at least one of text, two-dimensional image, three-dimensional image, video, advertisement, graphic, and hyperlink.

The system for a social media platform wherein the augmented reality content displayed to a specific user meeting specific criteria or requirements.

The system for a social media platform wherein the user interacts with the augmented reality content.

The method for a social media platform wherein the system comprises at least one augmented reality content generator and at least one user with a device displaying the augmented reality content.

The method for a social media platform wherein the system comprises at least two users.

The method for a social media platform wherein the augmented reality content is placed within one meter of the desired location, wherein the desired location is a user, device or predetermined intended location.

The method for a social media platform wherein the augmented reality content is placed within 50 centimeters of the desired location, wherein the desired location is a user, device or predetermined intended location.

The method for a social media platform wherein the augmented reality content is placed within 5 centimeters of the desired location, wherein the desired location is a user, device or predetermined intended location.

The method for a social media platform wherein the user location is updated continuously.

The method for a social media platform wherein the user location is updated in discrete time intervals.

The method for a social media platform wherein the microlocation technology is by any radiofrequency technology.

The method for a social media platform wherein the radiofrequency technology is UPS or cellular mobile communication.

The method for a social media platform wherein the radiofrequency technology is a wireless personal area network technology or Near Field Communication (NEC).

The method for a social media platform wherein the radiofrequency technology is a wireless networking technology based on the IEEE 802.11 family of standards or Ultra. Wideband (UWB).

The method for a social media platform wherein the content, placement or orientation of the augmented reality content is adjusted using the accelerometer, camera or compass of the user device.

The method for a social media platform wherein the augmented reality content is used for communicating between two or more users through their devices.

The method for a social media platform wherein the augmented reality content moves with the specific content generator.

The method for a social media platform wherein the augmented reality content is at least one of text, two-dimensional image, three-dimensional image, video, advertisement, graphic, and hyperlink.

The method for a social media platform wherein the augmented reality content displayed to a specific user meeting specific criteria or requirements.

The method for a social media platform wherein the user interacts with the augmented reality content.

### BRIEF DESCRIPTION OF FIGURES

FIG. 1 depicts the social media platform as seen by a social media platform member.

FIG. 2 depicts the social media platform system utilizing external hardware to determine location, where the user device is a receiver for transmitting hardware.

FIG. 3 depicts one possible equipment setup associated with the social media platform system of FIG. 2.

FIG. 4 depicts the social media platform system utilizing user warn transmitters and external hardware to determine location.

FIG. 5 depicts the equipment associated with the social media platform system of FIG. 4.

FIG. 6 depicts another possible equipment setup associated with the social media platform system of FIG. 2.

FIG. 7 depicts the social media platform system with the devices communicating directly to determine location.

FIG. 8 depicts the equipment associated with the social media platform system of FIG. 7.

FIG. 9 is a flowchart of the steps needed for operating the social media platform.

### DETAILED DESCRIPTION

The augmented reality platform and the system and method for operating the platform are described herein.

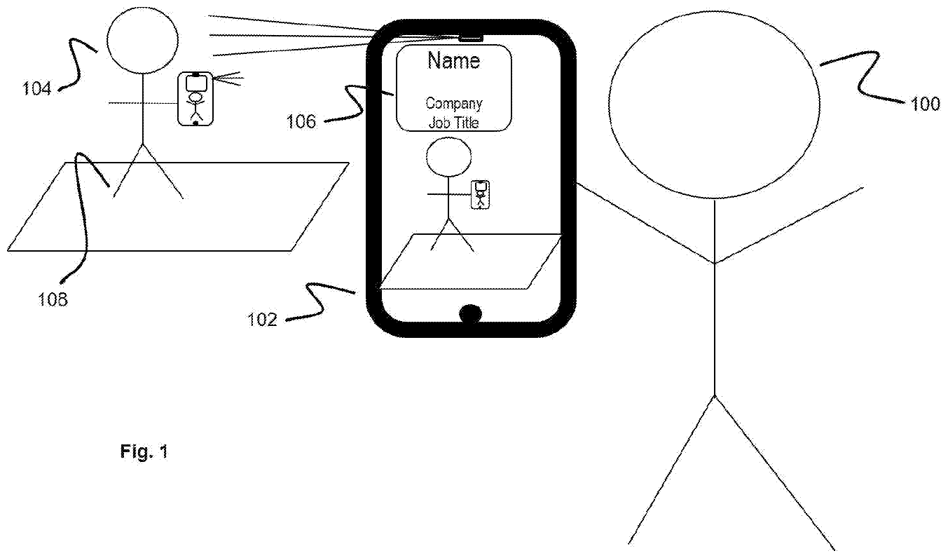

In general, FIG. 1 depicts the user experience of the social media platform. User 100 is pointing the device 102 at user 104. Device 102 is exaggerated to show detail. Augmented reality content 106 associated with user 104 is displayed on the device 102 of user 100. In this example scenario, the augmented reality content 106 of user 104 consists of name, company, and job title which is displayed in a bubble that appears to be floating over the location 108 of user 104 as viewed on the device 102 for user 100. In this example, only two users are illustrated but the system can be comprised of any number of users.

The augmented reality content may be any form of text including virtual name tags (e.g., name, company name, job title), personal message or status, bio (e.g. relationship status, interests, religion, etc.), and hyperlinks. The augmented reality content may also be 2D images, such as photographs, paintings, company logos, avatars, PDF files, presentation slides, and emojis; 3D images or models (e.g. CAD models, educational models, models of company products); virtual accessories or content that modify, replace, or add to the appearance of users (avatars, costumes, masks); icon or indicator for retail establishments, restaurants, and bars with indicator showing staff where a patron is in need of help or which patron to deliver goods or food to or conversely an indicator showing a patron where staff are located; advertisements; and social media or external sources, such as content derived from or linked to other social media platforms.

Additionally, any of these content types may be interactive, wherein the user can click on it on their device which performs one or more actions (e.g., modifies augmented reality content, leads to new augmented reality content, opens a new window on the device, or sends or receives content or messages or other data to or from other users). Content may also be tailored to different users with different users seeing different augmented reality content with an additional possible functionality that users may filter which content they want to see based on certain criteria or determine who they would like to show or hide their own content to or from.

The device may be a mobile phone, tablet, glasses, smart watch, projector, television, video monitor or any other device capable of displaying augmented reality content.

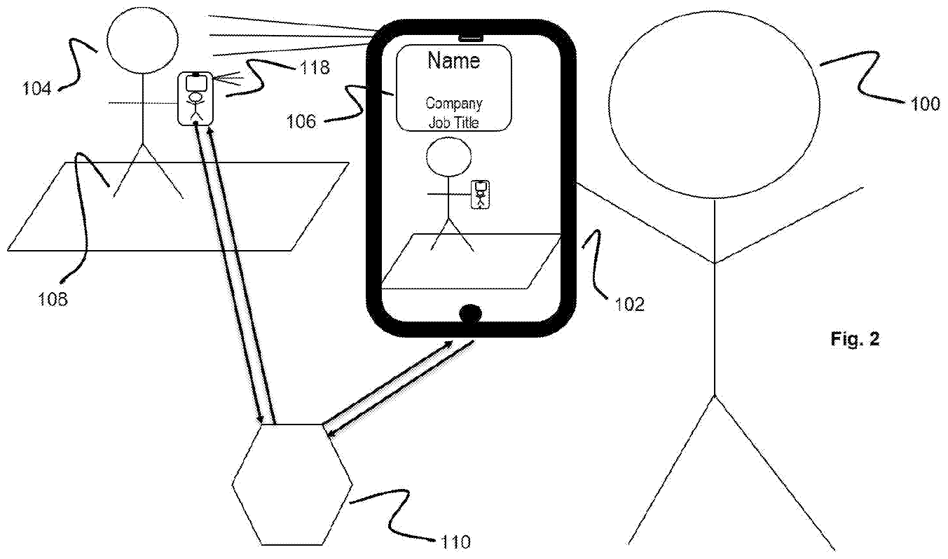

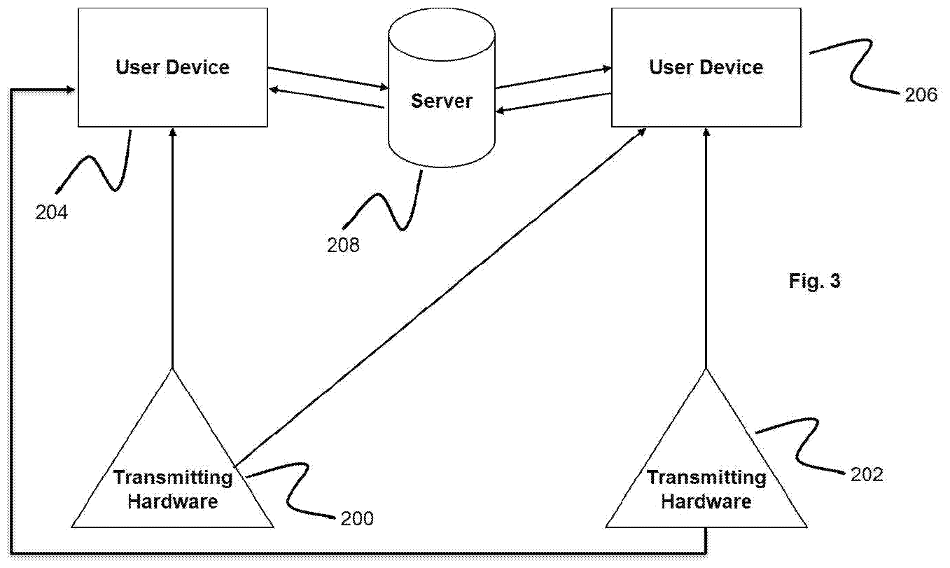

Several systems and methods may be used to determine the location of a user device within one meter. FIGS. 2 through 8 provide non-limiting examples of some systems. In an embodiment as shown in FIG. 2, external hardware 110 sends signals to user device 102 and user device 102 then computes the user position. For this invention, user position can be the position of an individual, a device or a predetermined intended location, including a location defined by a relative distance from an individual or device. Any and all devices in the vicinity of or included in the external hardware can receive the signals and compute the position of the specific user. User device 102 may not just receive data from but may also transmit data to external hardware 110, such as calculated location of device 102. As shown in FIG. 3, the user devices 204 and 206 then send their position to a server 208; alternatively, user devices 204 and 206 send the signal information from transmitting hardware 200 and 202 to the server 208 for determination of each device location. The server 208 then sends one, some, or all authorized received or calculated user locations to the user devices 204 and 206. In FIG. 2, two user devices are shown and in FIG. 3, two transmitting hardware devices and two user devices are shown; in practice, any number of external hardware and user devices may exist; the number of particular devices in all examples is non-limiting.

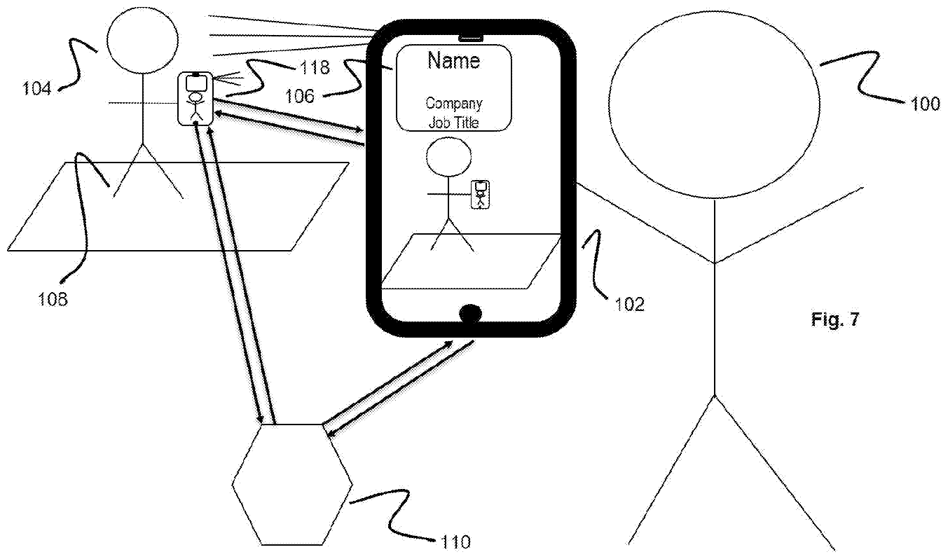

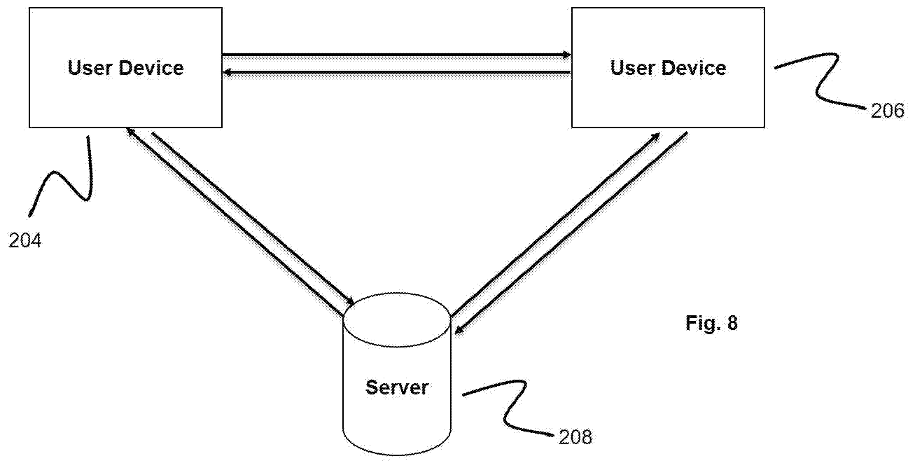

The server 208 and any additional servers are the central point for the social media platform. Server 208 receives, maintains and/or archives the user permissions, locations, user generated augmented reality content, user permissions and other factors of a social media platform and then transmits the information to the social media platform users. The server 208 may also be used for any computations related to determining the location of users, devices, or any hardware that is part of the system and may communicate with any devices or hardware that are part of the system. Alternatively in one embodiment shown in FIG. 7, user devices 102 and 118 may do all this independent of a server using direct communication between the devices. This can be enabled through the use of specific chips embedded in the user devices 102 and 118 such as used in the MIT Chronos System; this system determines relative location of a second device (e.g. 118) to a first device (e.g. 102). FIG. 8 shows such a system also using a server 208.

The user location does not need to be static. The user location may also refer to the user device or any hardware worn by the user, as it is assumed that the location of any devices or hardware coincides with the location of the user. Alternatively, two factor authentication could be utilized to verify that the location of any device coincides with the location of the user of that device. Using any of the envisioned user location systems, the user or device may move and the system will track the movements to update the location of the user in real time. The placement of the augmented reality content associated with the user or device may also then move with the user or device.

The external hardware 110 in FIG. 2 may be any that transmits and/or receives a signal or that can be used to help determine location, including the transmitting hardware 200 and 202 and the server 208 in FIG. 3, respectively. The external hardware 110 in FIG. 2 need not be present in the nearby vicinity and may be remote or off-site. The hardware may be using any location technology including GPS, cellular mobile communication (such as 5G networks), wireless personal area network technology such as Bluetooth Low Energy, wireless networking technologies based on the IEEE 802.11 family of standards commonly known as WiFi, Near Field Communication (NFC), Ultra Wideband (UWB), or other radiofrequency means. Two such hardware items can provide location but three or more hardware items provide better triangulation and if not all on the same elevation, then can also provide elevation or height of the user device such as whether on a first or second floor of an open atrium inside a building. The number of particular devices and hardware in all examples is non-limiting. A system of receivers and/or transmitters that pinpoint a user or device location to one meter or less is a microlocation technology.

Although current UPS technologies typically have a location error of three meters or more, new GPS technologies may enable sub-meter accuracy that only has error on the order of decimeters or even centimeters. For example, such a system may include the capabilities enabled by using the Galileo global navigation satellite system. Wireless personal area network technology such as Bluetooth Low Energy (BLE) can be used in systems to locate a user or device within one meter; microlocation systems incorporating BLE technology consist of transmitting hardware usually known as beacons. Ultra Wideband (UWB) technology can be used in systems to locate a user or device with decimeter accuracy; microlocation systems incorporating UWB technology consist of transmitting hardware worn by the user usually known as tags as well as receiving hardware usually known as anchors. Transmitting UWB chips are beginning to be directly built into devices (such as the U1 chip in the iPhone 11), eliminating the need for tags or anchors. Recent cellular mobile communication technologies (such as 5G networks) may be leveraged in systems such as Ultra-Dense Networks that could be used to locate a user or device with decimeter accuracy. Some algorithms allow for using chips built-in to devices in order to accurately determine the relative location between devices or user without the need for auxiliary hardware, such as the MIT Chronos System, which uses a wireless networking technology based on the IEEE 802.11 family of standards commonly known as WiFi. The microlocation technology that is used is not limited to these technologies and can be any technology that allows for location error that is at most 1 meter, preferably no greater than 50 centimeters and more preferably no greater than 5 centimeters.

The user devices 102 and 118 in FIG. 2 and their equivalent in 204 and 206 in FIG. 3 can communicate with the server 208 by any means including cellular service or a wireless networking technology based on the IEEE 802.11 family of standards commonly known as WiFi. The server 208 need not be present in the nearby vicinity and may be remote or off-site or both. The server 208 may not necessarily be separate from the transmitting hardware and may or may not be included in one or any of the transmitting hardware. In practice, any number of servers may exist.

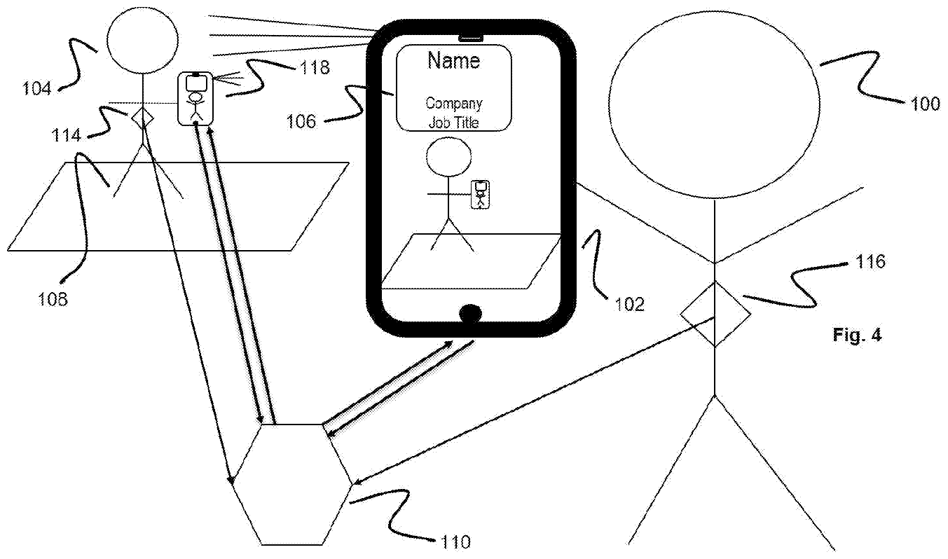

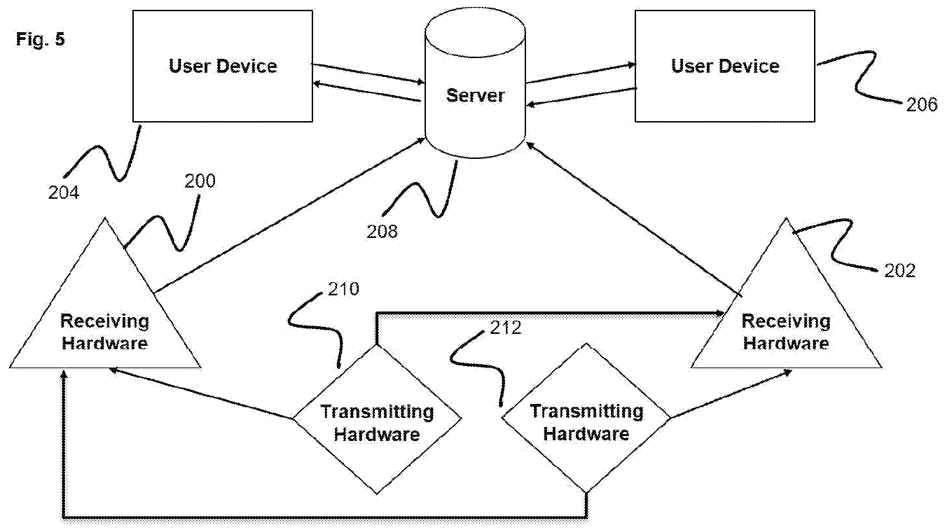

In an embodiment shown in FIG. 4, the users 100 and 104 wear transmitting hardware 114 and 116 that transmit to the external hardware 110. The external hardware 110 in FIG. 4 may be any that receive and/or transmit a signal or that can be used to help determine location, including the receiving hardware 200 and 202 and the server 208 in FIG. 5, respectively. The external hardware 110 in FIG. 4 need not be present in the nearby vicinity and may be remote or off-site. The hardware may be using any location technology including UPS, cellular mobile communication (such as 50 networks), wireless personal area network technology such as Bluetooth Low Energy, a wireless networking technology based on the IEEE 802.11 family of standards commonly known as Win, Near Field Communication (NFC), Ultra Wideband (MB), or other radiofrequency means. Server 208 can be used to transmit location to user devices 204 and 206 either calculated by or received from the external hardware 200 and 202. In FIG. 4, two user devices, two transmitting hardware worn by the user, and one external hardware are shown, and in FIG. 5, two receiving hardware devices, two user devices, two transmitting hardware worn by the user, and one server are shown; in practice, any number of external hardware, user devices, and hardware worn by the user may exist; the number of particular devices and hardware in all examples is non-limiting.

The user devices 102 and 118 in FIG. 4 and equivalently 204 and 206 in FIG. 5 can communicate with the server 208 by any means including cellular service or a wireless networking technology based on the IEEE 802.11 family of standards commonly known as WiFi. The server 208 need not be present in the nearby vicinity and may be remote or off-site or both. The server 208 may not necessarily be separate from the receiving hardware and may or may not be included in one or any of the receiving hardware. In practice, any number of servers may exist.

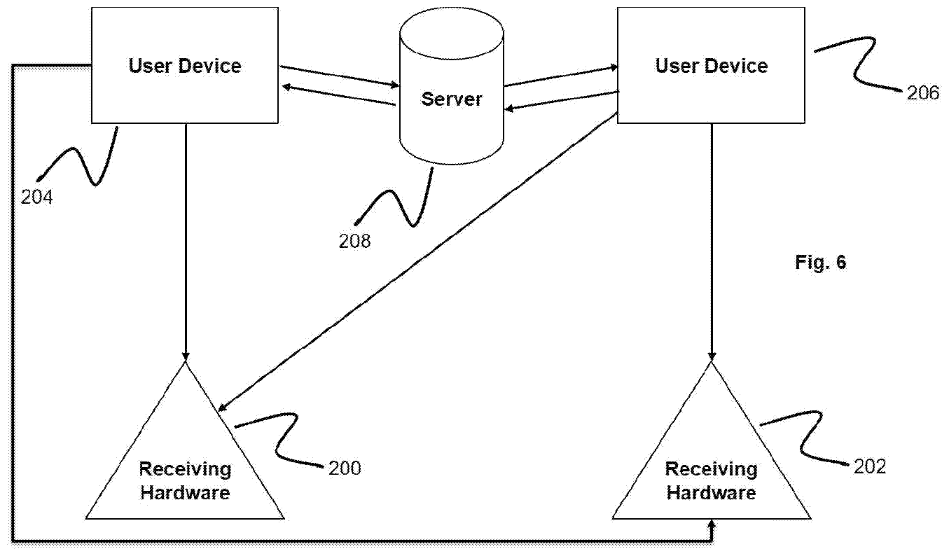

In another embodiment using FIG. 2, a system is outlined where the user devices 102 and 118 transmit directly to the external hardware 110 by using hardware or chips that may be built in to the user device. User devices 102 and 118 may not just transmit data to but may also receive data from external hardware 110. The external hardware 110 in FIG. 2 may be any that receive and/or transmit a signal or that can be used to help determine location, including the receiving hardware 200 and 202 and the server 208 in FIG. 6, respectively. The external hardware 110 in FIG. 2 need not be present in the nearby vicinity and may be remote or off-site. The hardware may be using any location technology including GPS, cellular mobile communication (such as 50 networks), wireless personal area network technology such as Bluetooth Low Energy, a wireless networking technology based on the IEEE 802.11 family of standards commonly known as Win, Near Field Communication (NFC), Ultra Wideband (UWB), or other radiofrequency means. Server 208 can be used to transmit location to user devices 204 and 206 either calculated by or received from the external hardware 200 and 202. In FIG. 2, two user devices are shown, and in FIG. 6, two receiving hardware devices, two user devices, and one server are shown; in practice, any number of external hardware and user devices may exist; the number of particular devices in all examples is non-limiting.

The user devices 102 and 118 in FIG. 2 and equivalently 204 and 206 in FIG. 6 can communicate with the server 208 by any means including cellular service or a wireless networking technology based on the IEEE 802.11 family of standards commonly known as WiFi. The server 208 need not be present in the nearby vicinity and may be remote or off-site or both. The server 208 may not necessarily be separate from the receiving hardware and may or may not be included in one or any of the receiving hardware. In practice, any number of servers may exist.

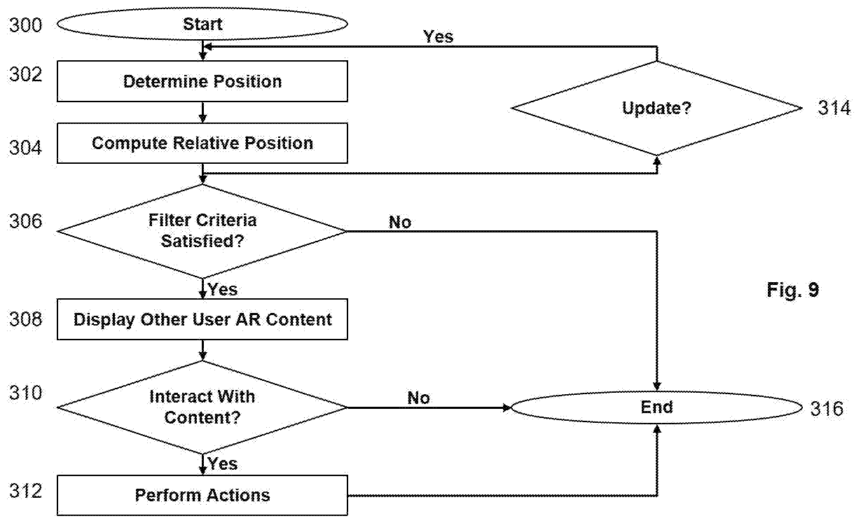

In another embodiment shown in FIG. 7, although external hardware 110 may exist, transmitting or receiving external hardware is not required to determine the locations of user devices 102 and 118. This can be enabled through the use of specific chips or hardware embedded in the user devices 102 and 118 such as used in the MIT Chronos System; this system determines relative location of a second device (e.g. 118) to a first device (e.g. 102). Other user devices may be required in order to determine the relative location of a second device to a first device. The specific chips or hardware embedded in the user devices can be any signal technology including GPS, cellular mobile communication (such as 50 networks), wireless personal area network technology such as Bluetooth Low Energy, a wireless networking technology based on the IEEE 802.11 family of standards commonly known as WiFi, Near Field Communication (NFC), Ultra Wideband (UWB), or other radiofrequency means. FIG. 8 shows such a system also using a server 208 which may be used for computing location. In FIGS. 8 and 9, two user devices and one server or external hardware are shown but in practice, any number of user devices may exist; the number of particular devices in all examples is non-limiting. The relative location can be computed for any device in the system relative to any other device.

The user devices 102 and 118 in FIG. 7 and equivalently 204 and 206 in FIG. 8 can communicate with the server 208 by any means including cellular service or a wireless networking technology based on the IEEE 802.11 family of standards commonly known as WiFi. The server 208 need not be present in the nearby vicinity and may be remote or off-site or both. The server 208 may not necessarily be separate from the transmitting hardware and may or may not be included in one or any of the receiving hardware. In practice, any number of servers may exist.

FIG. 9 is an example of a basic flowchart of some of the steps involved with a social media platform that tracks the location of the user and delivers the augmented reality content. The FIG. 9 flowchart describes the process for a receiving user viewing augmented reality content generated by other transmitting users, and it can be applied to all other transmitting users participating in the social media platform who also may have the ability to view the receiving user's augmented reality content. When entering the social media platform, the app or program starts at 300 and determines position by any means including those outlined previously at 302. User position and other relevant data is uploaded to a server(s); other relevant data may include anything required to perform functions by the specific application (time stamp, phone identifier, user name, other user information) as well as the user's own augmented reality content. The location of other users and relevant data associated with other users which may include that listed above is downloaded. At 304, the relative position from other users is determined and in some systems such as with the MIT Chronos System, this step may already be completed by internal algorithm(s). This information gives both distance and direction to other users.

On a continuous basis or on a time interval basis, the system determines at 314 if a user position update is needed. If yes, then the system returns to 302 to update the user position. This loop continues indefinitely during the process, such that the position steps are repeated if the update condition is met at any time, and this new relative position data is used in any of the following steps of the process.

At step 306, the process determines if filter criteria are satisfied for displaying augmented reality content to a specific user. As an example, the augmented reality content of another user is only displayed if certain criteria are satisfied. Non-limiting examples include that a transmitting user has a position that is within some distance from the receiving user, that a transmitting user has not blocked communication with the receiving user, that a transmitting user will only show augmented reality content to a receiving user meeting specific requirements or vice versa, the receiving user wants to be shown only augmented reality content from a transmitting user meeting specific requirements. Additionally, either transmitting or receiving user may also choose to have only some of the augmented reality data available displayed to the receiving user.

If filter conditions are met at 306, then in 308 the augmented reality content associated with the transmitting user is displayed on the device of the receiving user and appears to be floating in the vicinity of the transmitting user. The placement of the augmented reality content appears on the device of the receiving user is determined by the computed position or relative position in steps 302 and 304 and may also require additional information from a sensor(s) in the device of the receiving user device or from other relevant data.

Other inputs at step 306 could include using the compass/magnetometer in the device of the receiving user in order to determine the heading of device to place the augmented reality content in the correct location and/or define the orientation of the augmented reality content associated with the transmitting user as viewed by the receiving user. Alternatively, the accelerometer may be used to make slight adjustments in offsetting the position and/or orientation based on apparent movement of the receiving user from their computed position at the most recent position update. The camera may also be used to track the transmitting user or other objects in the scene in order to adjust the position and/or orientation based on the apparent motion of the transmitting user and/or the receiving user.

At step 310, the receiving user determines whether to interact with the displayed augmented reality content and if yes, actions are taken at step 312. These steps can be followed if the augmented reality content of the transmitting user is interactive wherein the entire augmented reality content (e.g., the entire name tag bubble) or just a part of the displayed augmented reality content (e.g., buttons, specific text, or hyperlink) is interactive. The receiving user can then click the interactive content on their device by touching where it appears on the screen.

At step 312, any possible action can be taken or can occur. As non-limiting examples, the content associated with the transmitting user changes as viewed on the device of the receiving user or may lead to another view with different content; the content associated with the receiving user may change as viewed on the device of the transmitting user or may lead to another view with different content; the original receiving user may send data to the original transmitting user which may or may not be via the server; and new data may be sent to the receiving user from the transmitting user which may or may not be via the server.

The AR display interaction ends at 316 when the filter criteria to display the AR content is not met or no further interaction with the AR content is desired by the user or transmitter or no further actions may be performed. The end may be the removal of the AR content from the display of the receiving device or by a static or changing AR display such as the transmitting user's name and phone number or an advertisement for a restaurant.

1. A social media platform displaying augmented reality content, the platform comprising augmented reality content appearing as a floating bubble near a content generator to at least one user, wherein microlocation technology is used to place the augmented reality content.

2. The social media platform of claim 1, wherein the augmented reality content is placed within one meter of the desired location, wherein the desired location is a user, device or predetermined intended location.

3. The social media platform of claim 1, wherein the augmented reality content is placed within 50 centimeters of the desired location, wherein the desired location is a user, device or predetermined intended location.

4. The social media platform of claim 1, wherein the augmented reality content is placed within 5 centimeters of the desired location, wherein the desired location is a user, device or predetermined intended location.

5. The social media platform of claim 1, wherein the user location is updated continuously.

6. The social media platform of claim 1, wherein the user location is updated in discrete time intervals.

7. The social media platform of claim 1, wherein the microlocation technology is by any radiofrequency technology.

8. The social media platform of claim 7, Wherein the radiofrequency technology is GPS or cellular mobile communication.

9. The social media platform of claim 7, wherein the radiofrequency technology is a wireless personal area network technology or Near Field Communication.

10. The social media platform of claim 7, wherein the radiofrequency technology is a wireless networking technology based on the IEEE 802.11 family of standards or Ultra Wideband.

11. The social media platform of claim 10, wherein the radiofrequency technology is a wireless networking technology based on Ultra Wideband.

12. The social media platform of claim 1, wherein the content, placement or orientation of the augmented reality content is adjusted using the accelerometer, camera or compass of the user device.

13. The social media platform of claim 1, wherein the augmented reality content is used for communicating between two or more users through their devices.

14. The social media platform of claim 1, wherein the augmented reality content moves with the specific content generator.

15. The social media platform of claim 1, wherein the augmented reality content is at least one of text, two-dimensional image, three-dimensional image, video, advertisement, graphic, and hyperlink.

16. The social media platform of claim 15, wherein the augmented reality content displayed to a specific user meeting specific criteria or requirements.

17. The social media platform of claim 15, wherein the user interacts with the augmented reality content.

18. A system for a social media platform displaying augmented reality content, the system comprising: a content generator of augmented reality, content appearing as a floating bubble near the content generator and at least one user viewing the augmented reality content, wherein microlocation technology is used to place the augmented reality content.

19. A method for a social media platform displaying augmented reality content, the method comprising: a means for a content generator showing augmented reality content near the content generator and a means for at least one user to view the augmented reality content, wherein microlocation technology is used to place the augmented reality content.

20. (canceled)

21. (canceled)
